(19) United States
(12) Patent Application Publication
(10) Pub. No.: US 2025/0001383 A1
(43) Pub. Date: Jan. 2, 2025

(54) MODULAR CAVITATION GENERATOR AND INTENSITY ADJUSTING METHODS

(71) Applicant: VIRGINIA TECH INTELLECTUAL PROPERTIES, INC., Blacksburg, VA (US)

(72) Inventors: Mingming Ge, Blacksburg, VA (US); Olivier Coutier-Delgosha, Blacksburg, VA (US)

(21) Appl. No.: 18/708,681

(22) PCT Filed: Nov. 22, 2022
(86) PCT No.: PCT/US2022/080313

§ 371 Date: May 9, 2024

Related U.S. Application Data
(60) Provisional application No. 63/282,419, filed on Nov. 23, 2021.

(51) Int. Cl. B01J 19/00; B01J 19/24; G01F 1/44

(52) U.S. Cl. CPC B01J 19/008; B01J 19/0013; B01J 19/2465; G01F 1/44; B01J 2219/00063; B01J 2219/00162; B01J 2219/00164

(57) ABSTRACT

A modular assembled cavitation generating device and related operating loop are described adapted for intensity adjustment, observation, and temperature control. The device is adapted to receive one or more modules detachably attachable to the device that define surface materials, dimensions, angles, and other parameters of a cavitation channel, such as a venturi cavitation channel, that controls or otherwise adjusts cavitation occurring within the device. The device further includes observation windows for monitoring, and various measurement sensors can be installed to obtain measurements pertaining to various flow fields. Additional methods for controlling and/or intensifying cavitation through setting an optimum temperature range are also described.

### CROSS-REFERENCE TO RELATED APPLICATION

This application claims the benefit of and priority to U.S. Provisional Patent Application No. 63/282,419 filed Nov. 23, 2022 entitled “MODULAR CAVITATION GENERATOR AND INTENSITY ADJUSTING METHODS,” the contents of which being incorporated by reference in their entirety herein.

### BACKGROUND

Hydrodynamic cavitation (HC) has been utilized for a wide variety of applications as a clean and renewable cavitating treatment technology. In the water treatment industry, for example, HC is effective in large-scale disinfection and waste effluent removal without introducing chemicals. For example, HC-assisted brewing can improve alcohol production, namely beer quality, energy efficiency, yield, and production time while retaining scalability, reliability, repeatability, stability, and manageability. Various cavitating treatments have been applied to increase mixing efficiency for biodiesel production from waste cooking oil and enhance the surface area of biochar.

### BRIEF SUMMARY

Various embodiments are disclosed for a modular cavitation generator, intensity adjusting methods, and related devices, systems, and methods, In a first aspect, a modular cavitation device is described that includes an inlet and an outlet; a cavitation body defining a venturi channel therein positioned between the inlet and the outlet, the cavitation body comprising a top surface, a first side surface, a second side surface opposite that of the first side surface, and a bottom surface, wherein: the top surface comprises a top surface receptacle; the bottom surface comprises a bottom surface receptacle, a first pressure port positioned on a first side of the bottom surface receptacle proximal to the inlet, and a second pressure port positioned on a second side of the bottom surface receptacle opposite that of the first side proximal to the outlet; the first side surface comprises a first side surface receptacle; and the second side surface comprises a second side surface receptacle; a venturi throat insert adapted to detachably attach to the cavitation body by at least partially nesting within the top surface receptacle or the bottom surface receptacle, the venturi throat insert configured to control a flow rate or a height of the venturi channel during cavitation; a transparent observation window positioned in at least one of the first side surface receptacle and the second side surface receptacle that exposes at least a portion of the venturi channel for observation; an upstream pressure gauge positioned at least partially within the first pressure port; and a downstream pressure gauge positioned at least partially within the second pressure port, wherein the upstream pressure gauge and the downstream pressure gauge are configured to determine at least one of pressure within the venturi channel and a flow rate of liquid within the venturi channel.

The venturi throat insert, when nested within the cavitation body, may define a cavity venturi section with a contraction section, a throat, and an expansion section. The venturi throat insert has an expansion angle that controls a cavitation intensity within the venturi channel. The venturi throat insert has atop surface having a material with a friction coefficient that controls the behavior of a cavitation cloud within the venturi channel. In some aspects, the venturi throat insert is formed of a transparent material for observation or light entry. At least one of the venturi throat inserts and the cavitation body may be formed through additive manufacturing (AM).

In some aspects, the transparent observation window is positioned in the first side surface receptacle, the modular cavitation device further comprises a side pressure gauge positioned in the second side surface receptacle, and the throat comprises a non-uniform surface having at least one indent therein.

In a second aspect, a modular cavitation device that includes a cavitation body defining a venturi channel therein positioned between an inlet and an outlet, the cavitation body comprising a top surface and a bottom surface; a top surface receptacle nested in the top surface; a bottom surface receptacle nested in the bottom surface; and a venturi throat insert adapted to detachably attach to the cavitation body by at least partially nesting within the top surface or the bottom surface, the venturi throat insert configured to control a flow rate or a height of the venturi channel during cavitation.

In some aspects, the cavitation body further comprises a first side surface and a second side surface opposite that of the first side surface, the cavitation body comprises a transparent observation window positioned on at least one of the first side surfaces and the second side surface that exposes at least a portion of the venturi channel, the bottom surface comprises a first pressure port and a second pressure port, the first pressure port is positioned on a first side of the bottom surface receptacle closest to the inlet, and the second pressure port is positioned on a second side of the bottom surface receptacle opposite that of the first side closest to the outlet.

In some aspects, the modular cavitation device further includes an upstream pressure gauge positioned at least partially within the first pressure port, and a downstream pressure gauge positioned at least partially within the second pressure port, where the upstream pressure gauge and the downstream pressure gauge are configured to determine at least one of pressure within the venturi channel and a flow rate of liquid within the venturi channel. The venturi throat insert, when nested within the cavitation body, defines a cavity venturi section with a contraction section, a throat, and an expansion section. The venturi throat insert has an expansion angle that controls a cavitation intensity within the venturi channel. The venturi throat insert has a top surface having a material with a friction coefficient that controls the behavior of a cavitation cloud within the venturi channel. The venturi throat insert may be formed of a transparent material for observation or light entry.

In a third aspect, a system is described that includes one of the modular cavitation devices described above, as well as a temperature-adjustable operating loop fluidly coupled to the modular cavitation device via the inlet and the outlet, comprising: a vacuum pump, a water tank, a water pump, a cooling circuit, a heating system, a flow meter, and a thermocouple.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, reference numerals designate corresponding parts throughout the several views.

FIG. 1 is a front, top perspective view of a modular cavitation device in accordance with various embodiments of the present disclosure.

FIG. 2 is a rear, bottom perspective view of a modular cavitation device in accordance with various embodiments of the present disclosure.

FIG. 3 is a top view of a modular cavitation device in accordance with various embodiments of the present disclosure.

FIG. 4 is a bottom view of a modular cavitation device in accordance with various embodiments of the present disclosure.

FIG. 5 is a first side view of a modular cavitation device in accordance with various embodiments of the present disclosure.

FIG. 6 is a second view of a modular cavitation device opposite that of FIG. 5 in accordance with various embodiments of the present disclosure.

FIG. 7 is a side cross-section view of a modular cavitation device with a callout region showing a venturi channel in accordance with various embodiments of the present disclosure.

FIG. 8 is a side cross-section view of a modular cavitation device showing a venturi channel in accordance with various embodiments of the present disclosure.

FIG. 9 shows various views of a top plate of a modular cavitation device defining a top surface thereof in accordance with various embodiments of the present disclosure.

FIG. 10 shows a bottom or top observation window for use with a modular cavitation device in accordance with various embodiments of the present disclosure.

FIG. 11 is a side observation window for use with a modular cavitation device in accordance with various embodiments of the present disclosure.

FIGS. 12-13 show various pressure gauges for use with a modular cavitation device in accordance with various embodiments of the present disclosure.

FIG. 14 shows a venturi throat insert for use with a modular cavitation device in accordance with various embodiments of the present disclosure.

FIG. 15 shows a hydrodynamic cavitation system in use with a modular cavitation device in accordance with various embodiments of the present disclosure.

FIGS. 16 and 17 are perspective views of a modular cavitation device having pressure gauges, observation windows, and a venturi throat insert installed in accordance with various embodiments of the present disclosure.

### DETAILED DESCRIPTION

The present disclosure relates to a modular cavitation generator, intensity adjusting methods, as well as various methods, systems, and devices associated therewith. Cavitation occurs due to a complex process of formation and collapse of bubbles in a liquid subject to pressure, density, and temperature variations. Generally, cavitation arises from energy and shockwaves released due to collapsing cavities. In hydrodynamic cavitation, for example, due to geometrical contraction in a flow channel, a local velocity is accelerated and cavities or bubbles are formed as a result of sudden pressure drops. These cavities are advected by a flow of liquid until a recovered pressure zone is met, then the cavities collapse. The collapse creates extreme conditions at localized areas with high temperatures or “hotspots” up to 5000 K, high pressures up to 1000 bar, as well as high oxidation (hydroxyl radicals). These phenomena can be destructive to microorganisms in water, cause molecules to fragment, and enhance chemical reactions and mass transfers in physical treatment processes. Cavitation can be generated via several methods such as hydrodynamic, particle, acoustic, and optic cavitation. Due to the limitation of ultrasound propagation and the high equipment cost of other device technologies, hydrodynamic cavitation is promising.

As noted above, hydrodynamic cavitation devices can be applied for water treatment and other large-scale industrial applications. However, prior techniques are not able to be efficiently used by adjusting cavitation intensity for various speeds and production environments, among other limitations. As cavitation devices of the related art are fixed in dimensions and shape, they do not have the capability of altering the flow channel size in a continuous treatment process. Moreover, cavitation control generally assumes operation under room temperature conditions without considering thermal effects. The related art, for example, does not offer efficient temperature ranges, such as those for producing a consumable beverage or water treatment, in the shortest amount of time possible.

Thus, according to various embodiments, an improved hydrodynamic cavitation device and system is described to overcome deficiencies in the related art. In accordance with various examples described herein, a hydrodynamic cavitation device is described that can be created through additive manufacturing (AM), such as three-dimensional printing. The cavitation device has an adjustable cavitation intensity in some embodiments. As such, various examples described herein offer low-complexity manufacturing and optimized costs of energy or maintenance, while enabling real-time monitoring of internal flow conditions. An operating system and methods to obtain an optimized operating temperature for cavitation intensification are also described which may be employed in various industrial settings such as, but not limited to, producing high-quality beverages or performing water treatment. At present, with the cost of energy rising rapidly, it is highly desirable to shorten the working time and lower energy consumption to secure as large a profit margin as possible. Accordingly, various embodiments are described herein for an intensity-adjustable, multi-observation, modular-assembled venturi device with a temperature-adjustable operating loop.

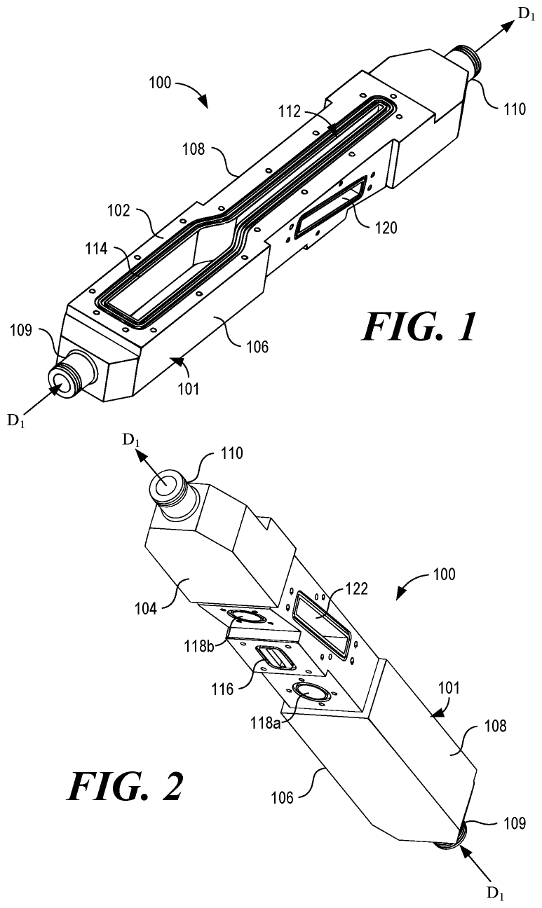

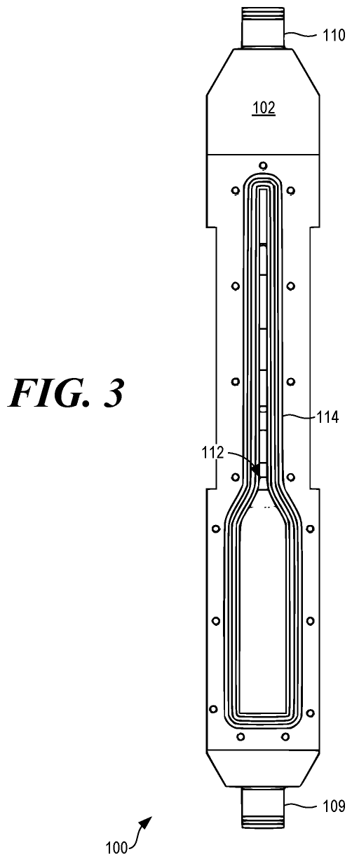

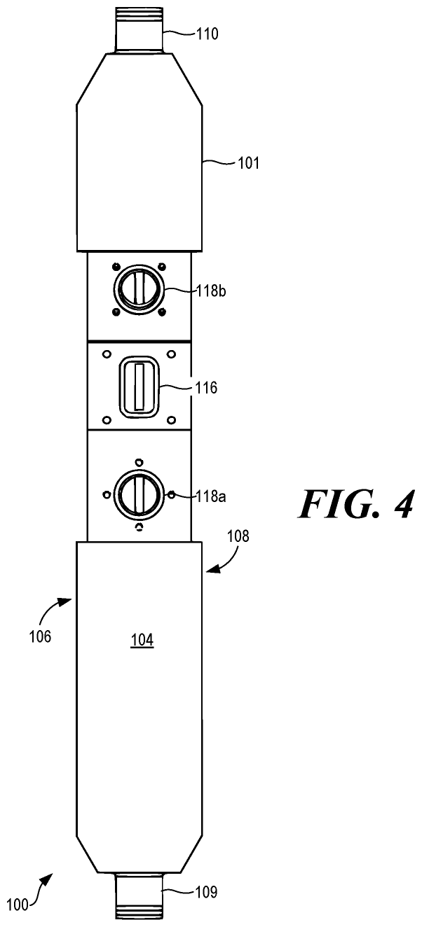

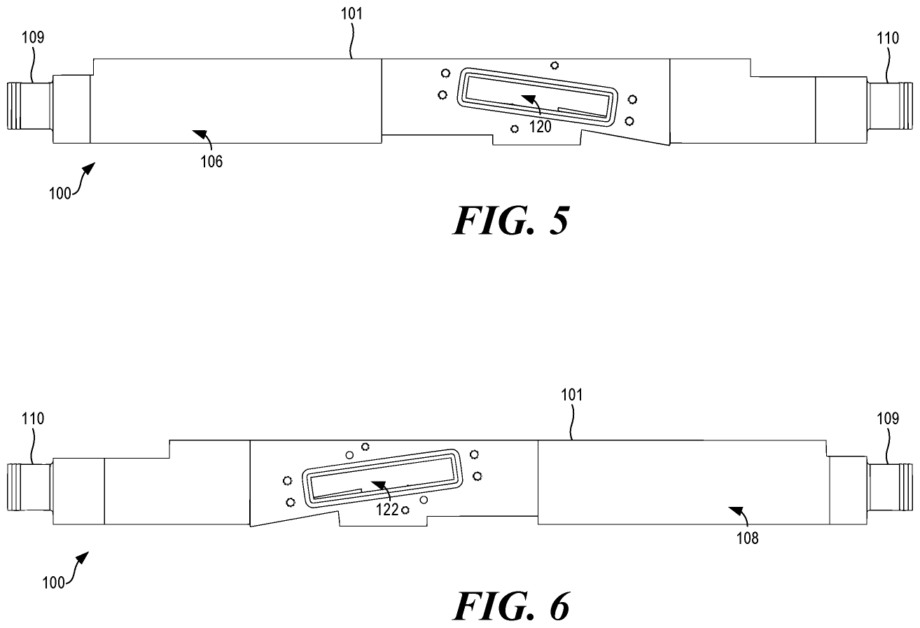

Turning now to the drawings, FIGS. 1 and 2 illustrate top and bottom perspective views of non-limiting examples of a modular cavitation device 100 according to aspects of the embodiments, FIGS. 3 and 4 illustrate top and bottom plan views of the modular cavitation device 100, and FIGS. 5 and 6 illustrate left and right side views of the modular cavitation device 100. Referring to FIGS. 1-6 collectively, the modular cavitation device 100 may include a cavitation body 101. The cavitation body 101 may extend along a longitudinal direction and, as such, may be generally rectangular in some embodiments. However, it is understood that additional shapes of the cavitation body 101 may be employed without deviating from the scope of the present disclosure.

The modular cavitation device 100 or, more specifically, the cavitation body 101 may include a top surface 102, a bottom surface 104, and side surfaces 106, 108. The cavitation body 101 may further include an inlet 109 and an outlet 110. The inlet 109 and/or the outlet 110 may include tubular members extending or projecting from a central portion of the rectangular-shaped cavitation body 101, for example. The tubular members may have a circular or ovular cross-section, although other cross-section shapes may be employed. The inlet 109 and/or the outlet 110 may include threads, whether female or male threads, or otherwise adapted for forming a threaded connection with a hose, tube, or other liquid provisioning device having a respective male or female threaded connector. While threaded connections are described, it is understood that other types of connections may be employed, such as interference connections, friction connections, clamp connections, snap connections, and the like.

The cavitation body 101 defines a venturi channel 112 therein, where the venturi channel 112 is positioned between the inlet 109 and the outlet 110, as will be described. As such, the top surface 102 of the cavitation body 101 may include a top surface receptacle 114. Further, the bottom surface 104 of the cavitation body 101 may include a bottom surface receptacle 116, a first pressure port 118a positioned on the first side of the bottom surface receptacle 116 proximal (e.g., closest) to the inlet 109, and a second pressure port 118b positioned on a second side of the bottom surface receptacle 116 opposite that of the first side proximal (e.g., closest) to the outlet 110.

The first side surface 106 may include a first side surface receptacle 120 and/or the second side surface 108 may include a second side surface receptacle 122. In some implementations, the first side surface receptacle 120 and/or the second side surface receptacle 122 may be angled relative to a normal plane of the cavitation body 101 such that the first end thereof is closer to the top surface 102 of the cavitation body 101 and the second end thereof is closer to the bottom surface 104 of the cavitation body 101.

Various modules may be detachably attached to and/or nested within the top surface receptacle 114, the bottom surface receptacle 116, the first pressure port 118a, the second pressure port 118b, the first side surface receptacle 120, the second side surface receptacle 122, as well as other areas of the modular cavitation device 100. As such, the modules may each include a portion configured to be positioned in (and/or nest in) a respective port or aperture. For instance, the modules may include projections similarly sized and/or shaped to be positioned in a respective port or aperture of the cavitation body 101.

A transparent observation window, for example, may be positioned in at least one of the first side surface receptacle 120 and the second side surface receptacle 122 via a projecting portion, where the transparent observation window exposes at least a portion of the venturi channel 112 for observation. In some embodiments, for example, the transparent observation window is positioned in the first side surface receptacle 120 and the modular cavitation device further comprises a side pressure gauge (not shown) positioned in the second side surface receptacle 122.

Additionally, a venturi throat insert may be adapted to detachably attach to the cavitation body 101 by at least partially nesting within the top surface receptacle 114 or the bottom surface receptacle 116, as will be described. The venturi throat insert may be sized and positioned, and formed of various materials, such that it is configured to control a flow rate or a height of the venturi channel 112 during cavitation.

In addition to the modules described above, an upstream pressure gauge may be positioned at least partially within the first pressure port 118a and/or a downstream pressure gauge may be positioned at least partially within the second pressure port 118b. The upstream pressure gauge and/or the downstream pressure gauge may be configured to determine at least one pressure within the venturi channel 112 and a flow rate of liquid within the venturi channel 112.

Generally, with reference to FIG. 1 for example, a fluid (e.g., water, alcoholic beverage, and the like) may flow in from the left side of the venturi channel 112 (e.g., via the inlet 109) and flow out from the right side (e.g., via the outlet 110). After plug-in modular installation of the modules, such as observation windows, pressure gauges, venturi throat inserts, and the like, an overall closed Venturi-type channel 112 may be initially formed.

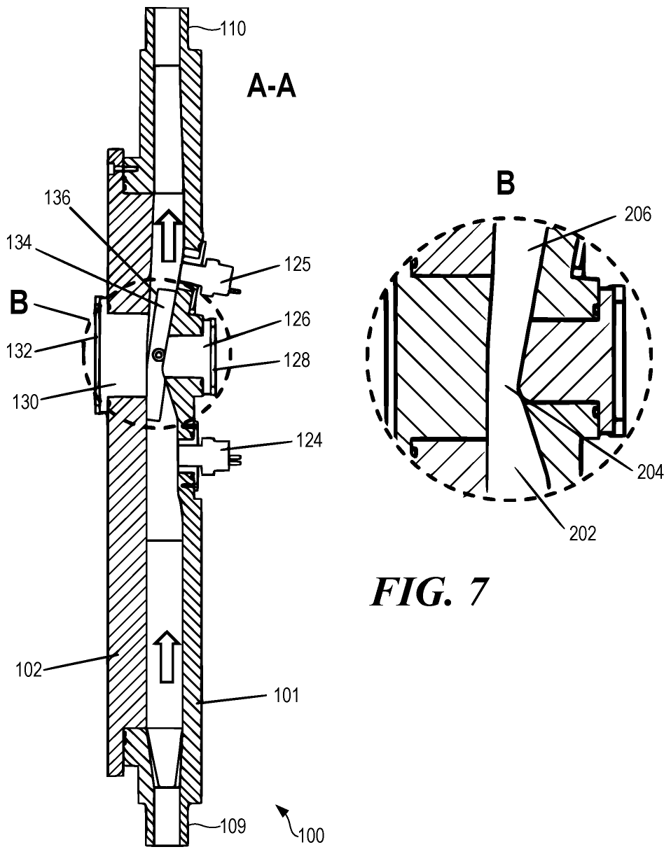

Moving along to FIG. 7, a cross-section view of the modular cavitation device 100 is shown having an upstream pressure gauge 124 positioned at least partially within the first pressure port 118a and/or a downstream pressure gauge 125 positioned at least partially within the second pressure port 118b. Additionally, FIG. 7 depicts a venturi throat insert 126 that is adapted to detachably attach to the cavitation body 101 by at least partially nesting within the bottom surface receptacle 116, for example. A venturi throat fixing part 128 may maintain the venturi throat insert 126 within the bottom surface receptacle 116 or other suitable areas. The venturi throat insert may be sized and positioned, and formed of various materials, such that it is configured to control a flow rate or a height of the venturi channel 112 during cavitation.

In some embodiments, the modular cavitation device 100 may further include a top observation window 130 and a top window fixing member 132 that secures the top observation window 130 to the cavitation body 101, for instance, via insertion within and connected to the top surface receptacle 114. Similarly, in some embodiments, the modular cavitation device 100 may further include a rear side observation window 134, the rear side window fixing part that secures the top observation window 130 to the cavitation body 101, for instance, via insertion within and connected to the top surface receptacle 114.

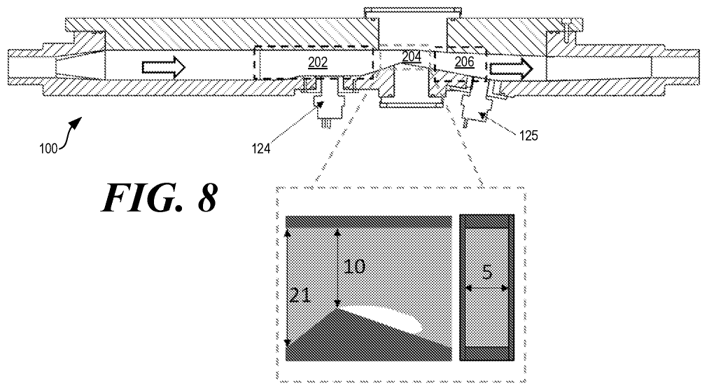

The upstream pressure gauge 124 and/or the downstream pressure gauge 125 may be configured to determine at least one pressure within the venturi channel 112 and a flow rate of liquid within the venturi channel 112. The venturi throat insert 126 may be spliced into a venturi-shaped channel (e.g., venturi channel 112) such that the venturi channel 112 has a contraction section 202, a throat section 204, and an expansion section 206 therein. The contraction section 202, the throat section 204, and the expansion section 206 are further illustrated in FIG. 8.

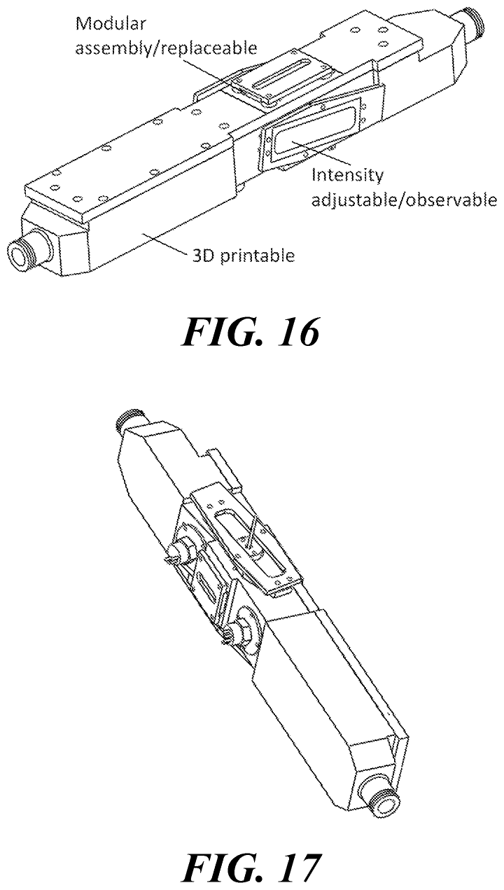

Referring again to FIG. 3, the top surface receptacle 114 or top opening of the cavitation body 101 may have a wide front (relative to the inlet 109) and a narrow arc transition shape, which is working under a plug-in connection with the top surface 102 and fixed by bolts or other suitable connection mechanisms. The side openings 120, 122 of the cavitation body 101 may be rectangular, and may be under plug-in connections with side observation windows that may be fixed by bolts with respective window fixing parts or other suitable connection mechanisms. There may be three openings on the bottom surface 104 of the cavitation body 101, of which the middle opening (e.g., bottom surface receptacle 116) is rectangular, which may be under a plug-in connection with the venturi throat insert 126, and which may be fixed by bolts with a bottom insert fixing part, for example. The pressure ports 118a, 118b on both sides of the bottom surface 104 of the cavitation body 101 may be rectangular in shape or circular in shape, respectively. The pressure ports 118a, 118b may be plug-in connected to a bottom upstream pressure gauge and a bottom downstream pressure gauge and installation parts thereof, and may be fixed by bolts or other connection mechanisms. FIGS. 16 and 17 are perspective views of the modular cavitation device 100 having pressure gauges 124, 125, observation windows, and a venturi throat insert 126 installed in accordance with various embodiments of the present disclosure.

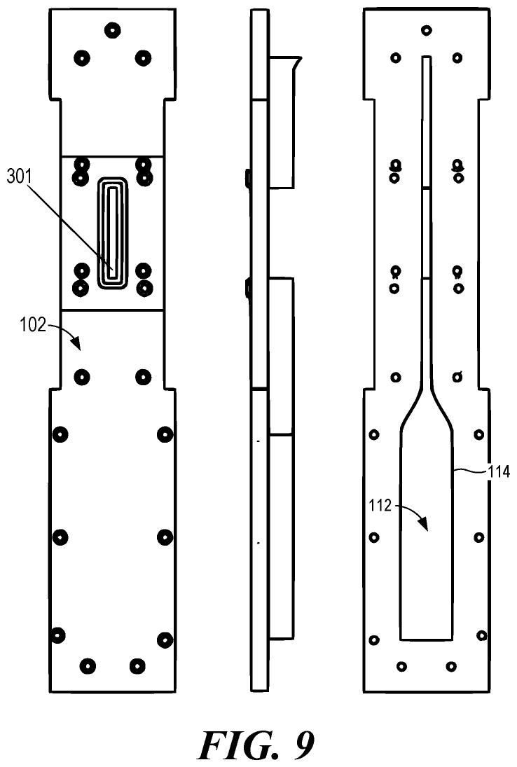

Referring now to FIG. 9, a top portion of the top surface 102 is shown, where in some embodiments a top opening 301 of the top surface 102 may be rectangular, and may be under a plug-in connection with a top observation window that is fixed by bolts with a top window fixing part.

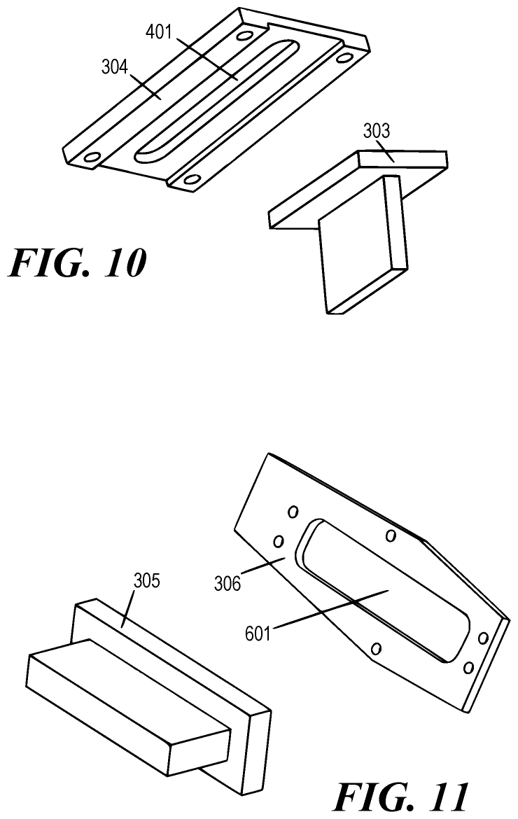

Moving along to FIG. 10, an example of a module that may be inserted into or otherwise detachably attached to the modular cavitation device 100. The module may include a top observation window 303 and/or a top window fixing member 304. The top observation window 303 may be inserted into the top surface 102, and may then be fixed by the top window fixing member 304. The top observation window 303 may be made of transparent glass for observation or light entry. The top window fixing member 304 may have an opening 401 for observation as well.

As shown in FIG. 11, a front side observation window 305 may be inserted and installed into cavitation body 101, and then it is fixed by the front side window fixing part 306. The front side observation window 305 may be made of transparent glass for observation or light entry. The front window fixing part 306 has an opening 601 for observation as well.

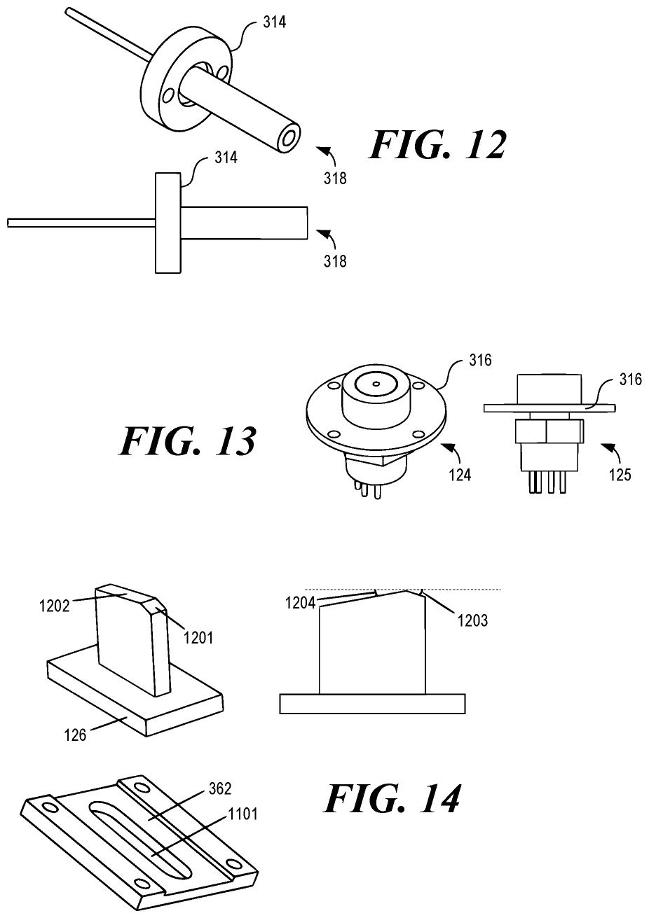

As shown in FIG. 12, a side pressure gauge 318 with its pressure gauge installation device 314 may be installed on the side observation window. Among them, the pressure gauge can be replaced with a sound level meter, thermometer, and other measuring devices to obtain different measurement information. The side pressure gauge 318, for example, can be installed with a side pressure gauge and an installation device (e.g., a plate secured via bolts) to obtain instantaneous side pressure information, if desired.

As shown in FIG. 13, the upstream pressure gauge 124 with its pressure gauge installation device 314 may be installed in the first (e.g., upstream) pressure port 118a of the cavitation body 101. The downstream pressure gauge 125 with its pressure gauge installation device 316 may have the same dimensions here, and may be installed in the second (e.g., downstream) pressure port 118b of the cavitation body 101. In various embodiments, a respective pressure gauge may be replaced with a sound level meter, thermometer, and other measuring devices to obtain different measurement information.

As shown in FIG. 14, a bottom insert fixing part 11 may be bolted to cavitation body 101 for fixing the venturi throat insert 126, for instance, the bottom surface of the cavitation body 101. The venturi throat insert 126 may be inserted into the bottom surface receptacle 116 installed on the cavitation body 101 in parallel, and its outer surface may closely fit the inner wall of the rectangular groove. The top surface of the venturi throat insert 126 may include two planes 1201 and 1202 spliced together or formed integral with one another, which may overlap with the inner wall of the bottom surface of cavitation body 101 to form the contraction section 202, the throat 204, and the expansion section 206 of the venturi channel 112, as shown in FIG. 7.

Referring again to FIG. 14, friction of the top surfaces 1201 and 1202 of the venturi throat insert 126 may be adjusted, for example, using different materials or coatings, which can adjust the behavior of a cavitation cloud. The first top surface 1201 may angle upwards at a flat apex or junction, where the first top surface 1201 has a width shorter than that of the second top surface 1202. Further, changing the apex angle of the venturi throat insert 126, i.e., the angle values of the contraction angle 1203 and the expansion angle 1204, can adjust the intensity of the cavitation cloud. The venturi throat insert 126 can be made of transparent glass for observation or light entry. Therefore, a venturi throat insert fixing part 362 has an opening 1101 for observation.

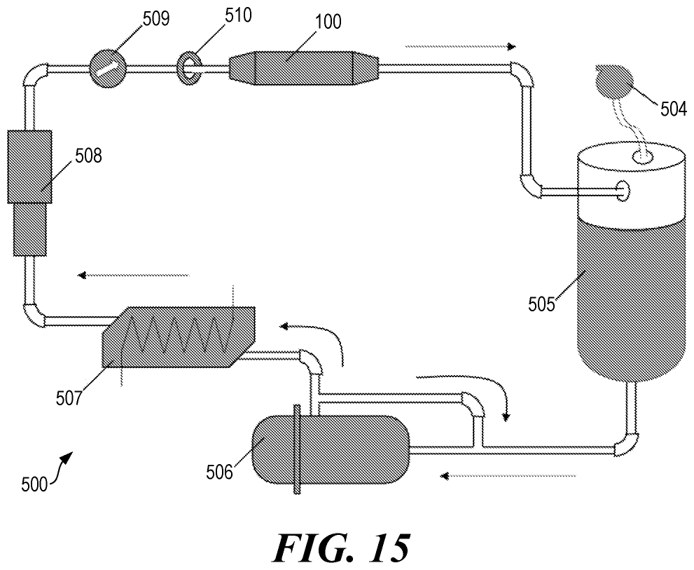

FIG. 15 is a diagram of a hydrodynamic cavitation system 500 according to an exemplary embodiment of the present disclosure. In addition to the modular cavitation device 100, the system 500 may also include a vacuum pump 504, a water tank 505, a water pump 506, a cooling circuit 507, a heating system 508, a flow meter 509, a thermocouple 510, as well as other components which will not be detailed for sake of brevity. As shown in FIG. 15, fluid (e.g., water or other liquid) may be pressurized by the water pump 516 to enter from the left side via inlet 109 and flow out from the right side via outlet 110. During operation, the fluid is fed from the water tank 505, which may be changed to a swimming pool, spa, pond, water feature (e.g., drinking fountain), water park, and the like in industrial settings. The pressure inside the whole loop can be adjusted by a vacuum pump 504 connected to the free surface of the fluid. A cooling circuit 507 together with the heating device 508 may be applied to stabilize a flow temperature. The flow meter 509 and the thermocouple 510 may be employed to measure flow velocity and temperature, respectively. Other additional sensors may be employed to generate various measurements. Generally, when the fluid velocity accelerates more than 10 m/s at the venturi throat, cavitation will occur.

The cavitation effect can be enhanced by various adjustment methods such as increasing the fluid flow rate, decompressing the pressure in the pipeline, sending air from the first pressure port 118a, reducing the friction on the top surface of the venturi throat insert 126, increasing the top angle of the venturi throat insert 126, and so on. On the contrary, the intensity of cavitation can also be reduced with countermeasures as mentioned above. These adjustments, replacement, and maintenance are efficient for the present invention, thanks to the relatively independent components and modular installation design.

At conditions where the component replacement is restricted, such as during the continuous water treatment process, temperature control may also be applied by the cooling circuit 507 and the heating device 508 to intensify the efficiency of hydrodynamic cavitation. As a result of numerous practical experiments, the temperature range of 55° C. to 60° C. is found to be optimum for the largest cavitation extent and the vigorous global vapor cloud shedding.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open-ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A modular cavitation device, comprising:
an inlet and an outlet;
a cavitation body defining a venturi channel therein positioned between the inlet and the outlet, the cavitation body comprising a top surface, a first side surface, a second side surface opposite that of the first side surface, and a bottom surface, wherein:
the top surface comprises a top surface receptacle;
the bottom surface comprises a bottom surface receptacle, a first pressure port positioned on a first side of the bottom surface receptacle proximal to the inlet, and a second pressure port positioned on a second side of the bottom surface receptacle opposite that of the first side proximal to the outlet;
the first side surface comprises a first side surface receptacle; and
the second side surface comprises a second side surface receptacle;
a venturi throat insert adapted to detachably attach to the cavitation body by at least partially nesting within the top surface receptacle or the bottom surface receptacle, the venturi throat insert configured to control a flow rate or a height of the venturi channel during cavitation;
a transparent observation window positioned in at least one of the first side surface receptacle and the second side surface receptacle that exposes at least a portion of the venturi channel for observation;
an upstream pressure gauge positioned at least partially within the first pressure port; and
a downstream pressure gauge positioned at least partially within the second pressure port, wherein the upstream pressure gauge and the downstream pressure gauge are configured to determine at least one of pressure within the venturi channel and a flow rate of liquid within the venturi channel.

2. The modular cavitation device according to claim 1, wherein the venturi throat insert, when nested within the cavitation body, defines a cavity venturi section with a contraction section, a throat, and an expansion section.

3. The modular cavitation device according to claim 1 or 2, wherein the venturi throat insert has an expansion angle that controls a cavitation intensity within the venturi channel.

4. The modular cavitation device according to claim 1, 2, or 3, wherein the venturi throat insert has a top surface having a material with a friction coefficient that controls behavior of a cavitation cloud within the venturi channel.

5. The modular cavitation device according to claim 1, 2, 3, or 4, wherein the venturi throat insert is formed of a transparent material for observation or light entry.

6. The modular cavitation device according to claim 1, 2, 3, or 4, wherein at least one of the venturi throat insert and the cavitation body are formed through additive manufacturing (AM).

7. The modular cavitation device according to claim 1, wherein:
the transparent observation window is positioned in the first side surface receptacle; and
the modular cavitation device further comprises a side pressure gauge positioned in the second side surface receptacle.

8. The modular cavitation device according to claim 2, wherein the throat comprises a non-uniform surface having at least one indent therein.

9. A modular cavitation device, comprising:
a cavitation body defining a venturi channel therein positioned between an inlet and an outlet, the cavitation body comprising a top surface and a bottom surface;
a top surface receptacle nested in the top surface;
a bottom surface receptacle nested in the bottom surface; and
a venturi throat insert adapted to detachably attach to the cavitation body by at least partially nesting within the top surface or the bottom surface, wherein the venturi throat insert is configured to control a flow rate or a height of the venturi channel during cavitation.

10. The modular cavitation device according to claim 9, wherein:
the cavitation body further comprises a first side surface and a second side surface opposite that of the first side surface; and
the cavitation body comprises a transparent observation window positioned on at least one of the first side surface and the second side surface that exposes at least a portion of the venturi channel.

11. The modular cavitation device according to claim 9 or 10, wherein:
the bottom surface comprises a first pressure port and a second pressure port;
the first pressure port is positioned on a first side of the bottom surface receptacle closest to the inlet; and
the second pressure port is positioned on a second side of the bottom surface receptacle opposite that of the first side closest to the outlet.

12. The modular cavitation device according to claim 11, further comprising:
an upstream pressure gauge positioned at least partially within the first pressure port; and
a downstream pressure gauge positioned at least partially within the second pressure port,
wherein the upstream pressure gauge and the downstream pressure gauge are configured to determine at least one of pressure within the venturi channel and a flow rate of liquid within the venturi channel.

13. The modular cavitation device according to claim 9, wherein the venturi throat insert, when nested within the cavitation body, defines a cavity venturi section with a contraction section, a throat, and an expansion section.

14. The modular cavitation device according to claim 9 or 13, wherein the venturi throat insert has an expansion angle that controls a cavitation intensity within the venturi channel.

15. The modular cavitation device according to claims 9, 13, or 14, wherein the venturi throat insert has a top surface having a material with a friction coefficient that controls behavior of a cavitation cloud within the venturi channel.

16. The modular cavitation device according to claims 9, 13, 14, or 15, wherein the venturi throat insert is formed of a transparent material for observation or light entry.

17. A system, comprising:
a modular cavitation device, comprising: a cavitation body defining a venturi channel therein positioned between an inlet and an outlet, the cavitation body comprising a top surface and a bottom surface; a top surface receptacle nested in the top surface; a bottom surface receptacle nested in the bottom surface; and a venturi throat insert adapted to detachably attach to the cavitation body by at least partially nesting within the top surface or the bottom surface, the venturi throat insert configured to control a flow rate or a height of the venturi channel during cavitation; and
a temperature-adjustable operating loop fluidly coupled to the modular cavitation device via the inlet and the outlet, comprising: a vacuum pump, a water tank, a water pump, a cooling circuit, a heating system, a flow meter, and a thermocouple.

18. The system according to claim 17, wherein:
the cavitation body further comprises a first side surface and a second side surface opposite that of the first side surface;
the cavitation body comprises a transparent observation window positioned on at least one of the first side surface and the second side surface that exposes at least a portion of the venturi channel;
the bottom surface comprises a first pressure port and a second pressure port;
the first pressure port is positioned on a first side of the bottom surface receptacle closest to the inlet; and
the second pressure port is positioned on a second side of the bottom surface receptacle opposite that of the first side closest to the outlet.

19. The system according to claim 18, further comprising:
an upstream pressure gauge positioned at least partially within the first pressure port; and
a downstream pressure gauge positioned at least partially within the second pressure port,
wherein the upstream pressure gauge and the downstream pressure gauge are configured to determine at least one of pressure within the venturi channel and a flow rate of liquid within the venturi channel.

20. The modular cavitation device according to claim 17, wherein the venturi throat insert, when nested within the cavitation body, defines a cavity venturi section with a contraction section, a throat, and an expansion section.
